(19) United States
(12) Patent Application Publication
(10) Pub. No.: US 2005/0239033 A1
(43) Pub. Date: Oct. 27, 2005

(54) Interactive training system for packing

(76) Inventors: William Hatcher, Overland Park, KS (US); Roger Ruetten, Stillwater, MN (US)

Correspondence Address: JAMES D IVEY, 3025 TOTTERDELL STREET, OAKLAND, CA, 94611-1742, US

(21) Appl. No.: 10/815,469

(22) Filed: Mar. 31, 2004

(51) Int. Cl. G09B 3/00

(52) U.S. Cl. 434/350

(57) ABSTRACT

A computer game paradigm is used to train trainees in the skill of packing shopping bags. A number of items appearing on a conveyor in the computer game are packed into one or more bags in accordance with user input gestures of the trainee using graphical user interface techniques. The trainee is able to rotate items to make them fit within a bag in relation to positions of other items already within the bag. In addition, the trainee is able to move items within the bag to occupy different positions within the lateral boundaries of the bag. The computer game can be served through a computer network, such as the Internet or a LAN, as an applet or otherwise active web page. Accordingly, the trainee can practice or completely self-teach the skills of bagging from the comfort and convenience of any computer connected to such a network.

### FIELD OF THE INVENTION

This invention relates to the field of computerized training systems, and more specifically to a computerized training system for packing of items into bags and/or boxes.

### BACKGROUND

Grocery and many retail stores operate on very thin margins and compete heavily for customers. Judicious use of bags into which purchased items are packed affects competitiveness of such stores in at least two ways. First, bags in which customers carry their purchased items are given to the customers free of charge. Second, the manner in which the bags are packed by a clerk is an essential part of the overall customer service experience and the last impression left upon the customer as they travel home.

In the former context, bags are an expense borne by the store as a courtesy to the customer. While individual bags aren't particularly expensive, that expense scaled by the volume of bags dispensed to customers represents a significant expense. In addition, efficiency in use of bags can vary widely, causing significant swings in the aggregate expense of bags. For example, if a collection of items which could be packed into two (2) bags is routinely packed inefficiently into three (3) bags, the expense of providing bags to the store's customers is 50% higher than it should be. In practice, it is not uncommon for the number of bags used to exceed the number of necessary bags by more than 50%.

In the latter context, poor packing technique can leave the customer with bags which are difficult to carry and/or in which merchandise is damaged. For example, some bags can be packed too heavily or bags can be packed with uneven weight distribution. Such can make carrying the bags awkward and difficult. In addition, if the clerk fails to avoid packing heavy items on top of fragile or crushable items, the fragile or crushable items can be damaged in transport. If the clerk packs incompatible items in the same bag, such as meat and soap in the same bag, the merchandise can become spoiled or otherwise unusable.

Thus, training in proper packing technique is paramount to success in the grocery business as well as in other businesses. General retail businesses, particularly high-end retail, use bags and/or boxes, which are collectively referred to herein as packages, which can be relatively expensive and customer service is of particular importance. Judicious use of packages, along with professionalism and attention to detail in placing purchased items in such packages, reduce costs to the business and provide the business with a very professional and welcoming appearance to customers.

The problem of bag packing is particularly important with respect to polyethylene retail carrier bags (sometimes referred to as PRCBs). PCRBs are very popular in various retail stores because of their low cost. However, PCRBs can require more skill to pack properly than do other types of packages. In particular, PCRBs provide virtually no structure and do not stand on their own. In addition, over-packed and over-weight PCRBs can be uncomfortable for customers to carry as the handles can press hard into the customer's hand.

The best type of training typically used is in-person training in which the clerk is given instruction and an opportunity to practice packing technique. However, the one-on-one packing teaching is expensive in terms of manpower and in terms of setting up an environment which simulates movement of items purchased by a customer. Another type of training typically used is instructional video tapes or other multimedia presentations regarding packing technique. The primary disadvantage of this type of training is the passive nature of the training. The clerk simply passively watches a video presentation. Due to the passive nature of this type of training, the clerk can easily devote less than full attention to the topic during the training session. In addition, what may appear to the clerk to be easy to do while watching the video presentation may, in fact, be much more difficult to do in actuality.

What is needed is an active training system for packing of purchased merchandise wherein the training system is relatively inexpensive such that recurrent training can be applied liberally to clerks.

### SUMMARY OF THE INVENTION

In accordance with the present invention, a computer game paradigm is used to train trainees in the skill of packing bags. A number of items appearing on a conveyor in the computer game are packed into one or more bags in accordance with user input gestures of the trainee using graphical user interface techniques. The trainee is able to rotate items to make them fit within a bag in relation to positions of other items already within the bag. In addition, the trainee is able to move items within the bag to occupy different positions within the lateral boundaries of the bag. This computer game paradigm is applicable to packing generally any type of items into various types of packages, such as boxes or shopping bags, including paper bags, canvas bags, net bags, plastic bags, and PRCBs for example.

Scoring is applied to the placement of items within the bags. For example, non-crushable items should be placed in the bottom of the bags and around the perimeter to provide a secure and sound foundation. Such a foundation is of particular importance in PCRBs. Glass items can be placed in the bottom of the bags but should not be placed in corners where the glass items can be subject to excessive concussions as the bag is carried about. Crushable items should not be place under other items. Weight should be relatively evenly distributed between the bags. And, the number of bags used should be minimized.

By simulating the bag packing environment in a computer game, trainees can learn the art of bag packing, sometimes referred to as bagging, away from actual customers without using an actual bagging station and/or cash register environment. Such an actual environment can require an elaborate physical training station at considerable expense or can require off-hours use of an actual bagging station within a store at considerable inconvenience to the trainer and trainee.

The computer game simulating the bag packing environment can be served through a computer network, such as the Internet or a LAN, as an applet or otherwise active web page. Accordingly, the trainee can practice or completely self-teach the skills of bagging from the comfort and convenience of any computer connected to such a network.

Scores of individual trainees are recorded and stored in a database such that administrators can observe training activity and performance of such trainees. Accordingly, such administrators can identify trainees who might not be ready to pack items purchased by actual customers, either by failure to adequately train using the simulated bag packing environment or by failure to improve scores within the simulated bag packing environment. Such trainees can be given individual attention prior to bagging items for actual customers—thereby significantly improving satisfaction of the customers in the manner in which purchased items are bagged.

### BRIEF DESCRIPTION OF THE DRAWINGS

FIGS. 1-16 are screen views of a simulated bag packing environment implemented according to a computer game paradigm in accordance with the present invention.

FIG. 17 is a block diagram of a computer system in which the simulated bag packing environment of FIGS. 1-16 is implemented in accordance with the present invention.

FIG. 18 is a block diagram of the trainer logic of FIG. 17 in greater detail.

FIG. 19 is a block digram of an item record of the item database of FIG. 18 in greater detail.

FIG. 20 is a block diagram of the performance tracker of FIG. 17 in greater detail.

FIG. 21 is a block diagram of a trainee record of the trainee database of FIG. 20 in greater detail.

FIG. 22 shows examples of item types represented within the item database of FIG. 18.

FIG. 23 shows an example performance report generated from the trainee database of FIG. 20.

### DETAILED DESCRIPTION

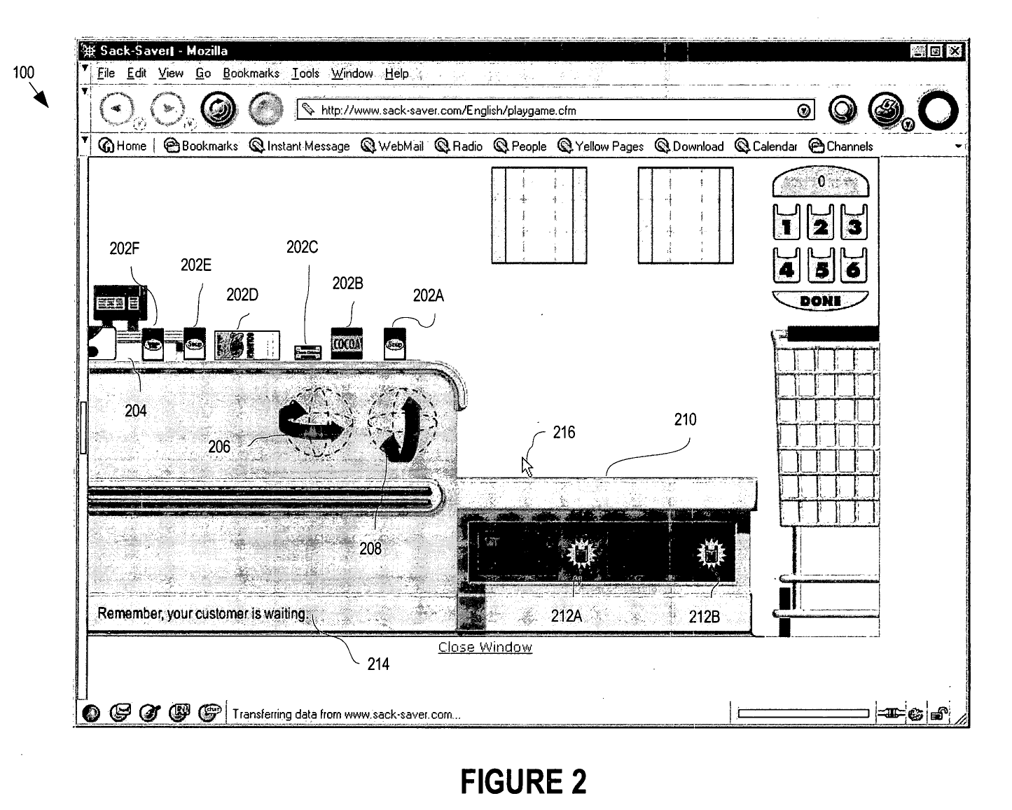

In accordance with the present invention, a computer game paradigm is used to train clerks in the art of packing purchased items. In this illustrative embodiment, the computer game paradigm simulates a bag packing environment in which a number of grocery items 202A-F (FIG. 2) move along a conveyor 204 toward a platform 210. While a grocery store is used as a context for simulated bag packing in this illustrative example, it should be appreciated that the techniques described herein are equally applicable to packing of packages in other environments.

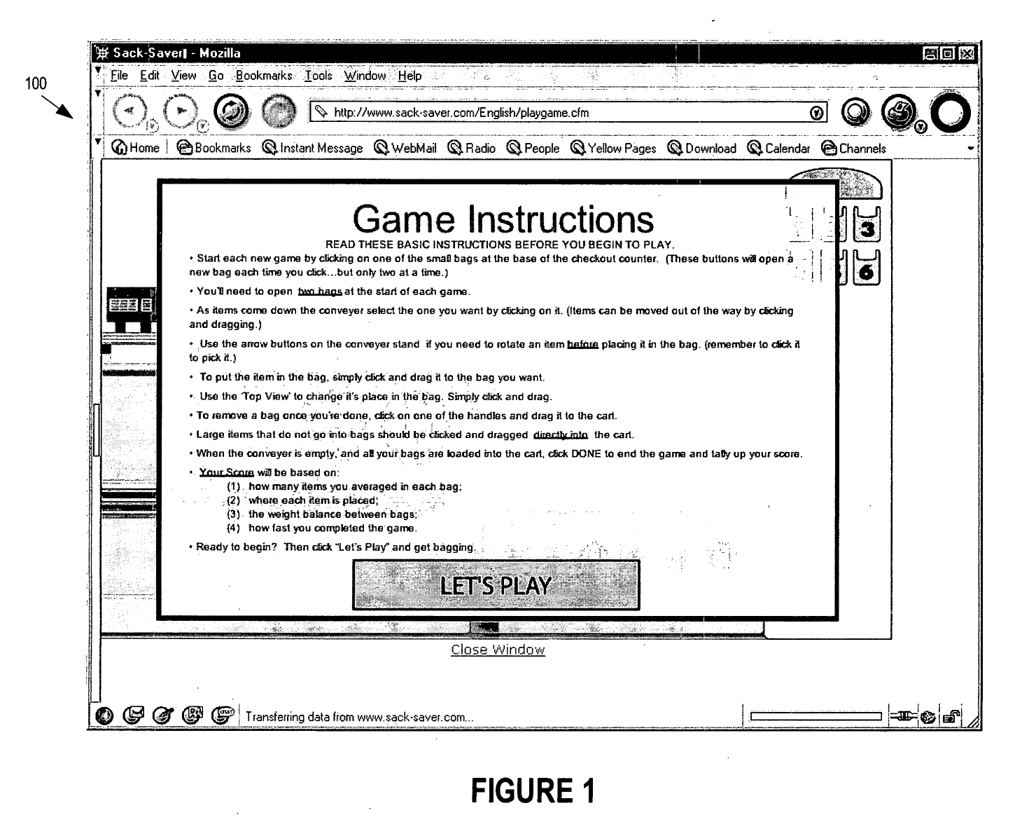

The trainee using the computer simulation shown in FIGS. 1-16 uses graphical user interface (GUI) controls such as rotate buttons 206-208 (FIG. 2) and new bag buttons 212A-B and drag-and-drop interfaces to control simulated packing of bags. Upon completion of a round of bag packing, the trainee is evaluated on a number of packing criteria and provided with helpful suggestions in improving bag packing proficiency, and therefore future scores in future simulated bag packing sessions in the game shown in FIGS. 1-16.

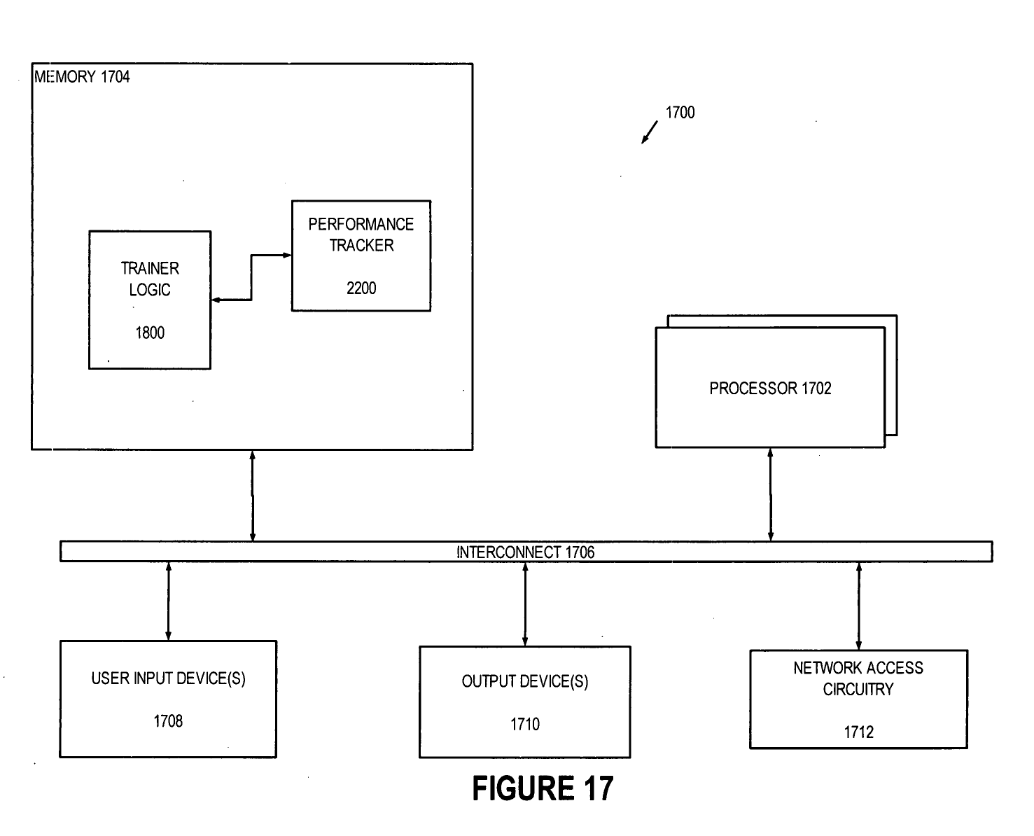

In this illustrative embodiment, the game of FIGS. 1-16 operates in a computer system of generally conventional architecture as shown in FIG. 17. This architecture is briefly described to facilitate appreciation and understanding of the present invention.

Computer system 1700 (FIG. 17) is generally of the same architecture as most computers available today. Computer system 1700 includes one or more microprocessors 1702, each of which retrieves data and/or instructions from memory 1704 and executes retrieved instructions in a conventional manner. Memory 1704 can include generally any type of computer-readable memory such as randomly accessible memory (RAM), read-only memory (ROM), and persistent storage media such as magnetic and/or optical disks whether removable or installed in a non-removable manner.

Microprocessors 1702 and memory 1704 are connected to one another through an interconnect 1706 which is a bus in this illustrative embodiment. Interconnect 1706 is also connected to one or more user input devices 1708, one or more output devices 1710, and network access circuitry 1712. Input devices 1708 can include generally any user input devices such as a keyboard, a keypad, pointing devices such as mice and trackballs, tablets, a touch pad, a touch-sensitive screen, and video game controllers, for example. Input devices 1708 generate signals which are sent through interconnect 1706 to microprocessors 1702 in response to physical manipulate by a user. Output devices 1710 can include generally any output device such as a computer monitor, a television, or a touch-sensitive display screen, for example.

Network access circuitry 1712 can be generally any network connection such as a modem or any type of ethernet network adapter, for example. In addition to executing instructions retrieved from memory 1704, microprocessors 1702 can receive instructions with any appurtenant data through network access circuitry 1712 for execution. Such instructions and/or data received through network access circuitry 1712 can be stored in memory 1704 to facilitate efficient execution by microprocessors 1702.

Memory 1704 includes trainer logic 1800 and a performance tracker 2000. In this illustrative embodiment, trainer logic 1800 and performance tracker 2000 are each all or part of one or more computer processes executed by microprocessors 1702 from memory 1704 and/or from network access circuitry 1712. In this illustrative embodiment, trainer logic 1800 and performance tracker 2000 are implemented in the ColdFusion® programming language of Macromedia, Inc. of San Francisco, Calif.

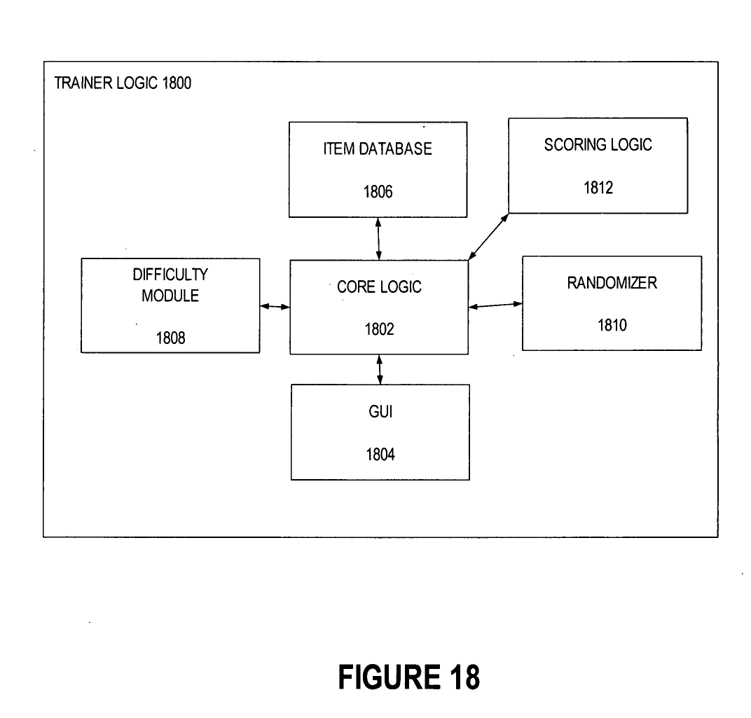

Trainer logic 1800 is shown in greater detail in FIG. 18. Trainer logic 1800 includes a core logic 1802 which defines the play and interaction of the simulated bag packing experience shown in FIGS. 1-16. A graphical user interface (GUI) 1804 (FIG. 18) processes system-level user interaction though input devices 1708 and output devices 1710 to implement a user interface defined by core logic 1802. An item database 1806 specifies characteristics of items which the trainee is to fit into bags, e.g., items 202A-F (FIG. 2), such as item appearance, size, weight, etc. Item database 1806 is described more completely below. A difficulty module 1808 identifies characteristics of the simulation implemented by core logic 1802 which can be modified to adjust the difficulty of the simulated bag packing experience of the trainee in accordance with the skill level of the trainee. These characteristics and the manner in which difficulty module 1808 adjusts them are described more completely below. A randomizer 1810 generates pseudo-random numbers in accordance with random number distributions which simulate real-world experiences in packing purchased items. Scoring logic 1812 evaluates the performance of the trainee in the simulated packing of bags to thereby attribute a score to that performance. Scoring logic 1812 is described more completely below.

The trainee's experience generally begins with screen view 100 (FIG. 1) which includes a description 102 of general instructions for the simulated bag packing experience. Screen view 100 is of a conventional web browser displaying a ColdFusion® page whose interactivity is specified by core logic 1802 (FIG. 18) in ColdFusion® Mark-up Language (CFML) in this illustrative example. Once the instructions of description 102 (FIG. 1) have been reviewed and acknowledged by the trainee, the simulate bag packing begins generally as shown in FIG. 2.

A number of items, e.g., items 202A-F, move along a conveyor 204 toward a packing platform 210. Much like a grocery clerk, core logic 1802 (FIG. 18) causes conveyor 204 (FIG. 2) to stop when an item reaches the end of conveyor 204 nearest packing platform 210. A cursor 216 is controlled by the trainee in a conventional user-interface manner involving physical manipulation of one or more of input devices 1708 (FIG. 17). A message 214 (FIG. 2) helps to motivate the trainee.

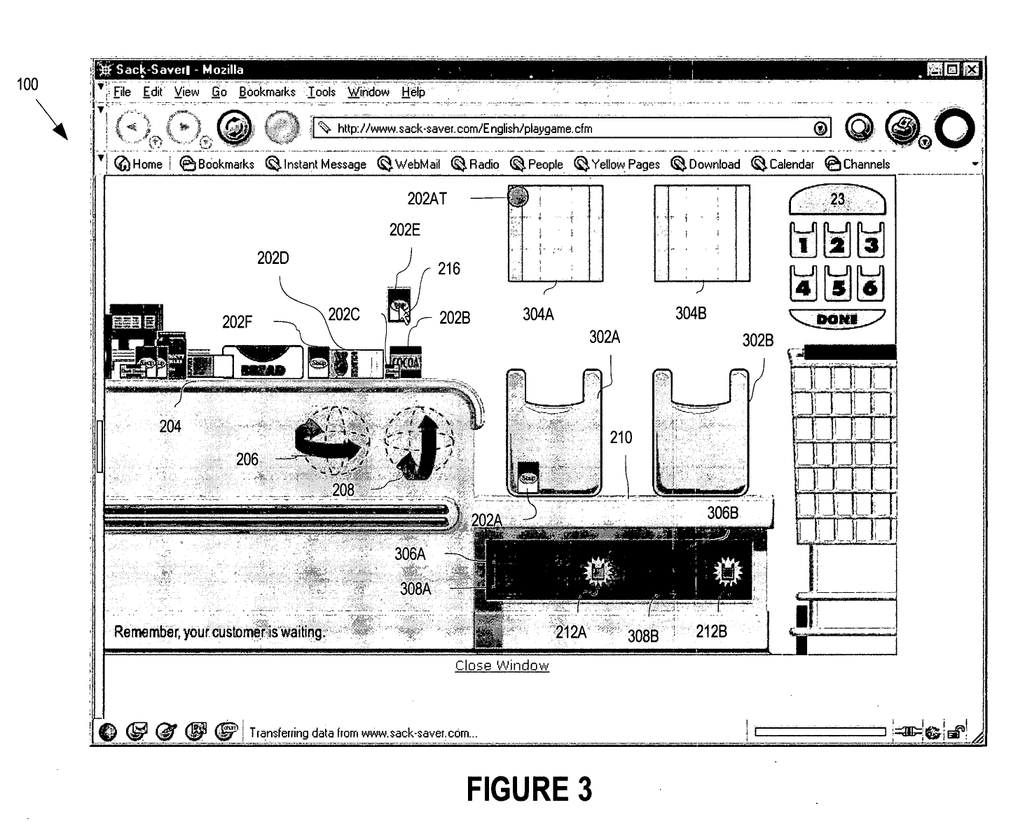

The trainee requests a new bag on packing platform 210 by clicking on either new bag button 212A or new bag button 212B with cursor 216. Specifically, in response to clicking on new bag buttons 212A-B, core logic 1802 (FIG. 18) causes bags 302A-B (FIG. 3), respectively, to be displayed. Overhead views 304A-B correspond to bags 302A-B, respectively. Using a common and conventional drag-and-drop user input gesture, the trainee drags items from conveyor 204 to either of bags 302A-B. Item 202E is shown in FIG. 3 to be in the process of being dragged by the trainee. Upon being dropped into a bag, the item is shown in the bag in both the side view and the overhead view. For example, item 202A is shown in the side view of bag 302A and a top view 202AT is simultaneously shown in overhead view 304A.

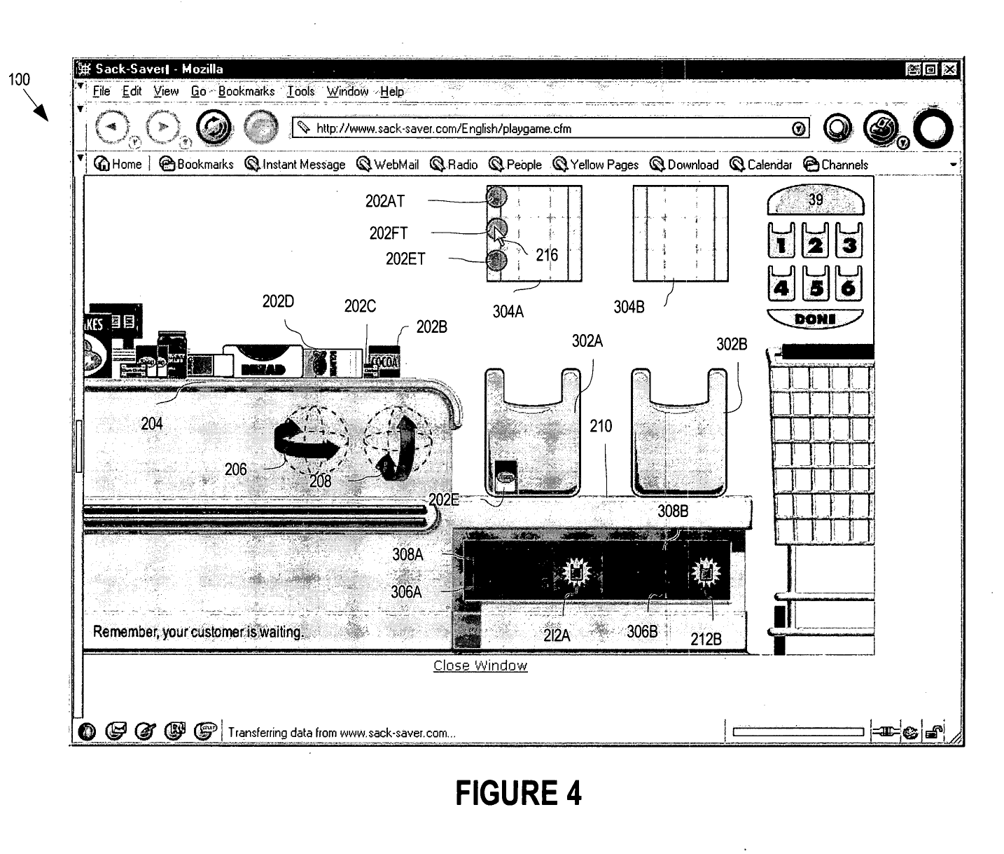

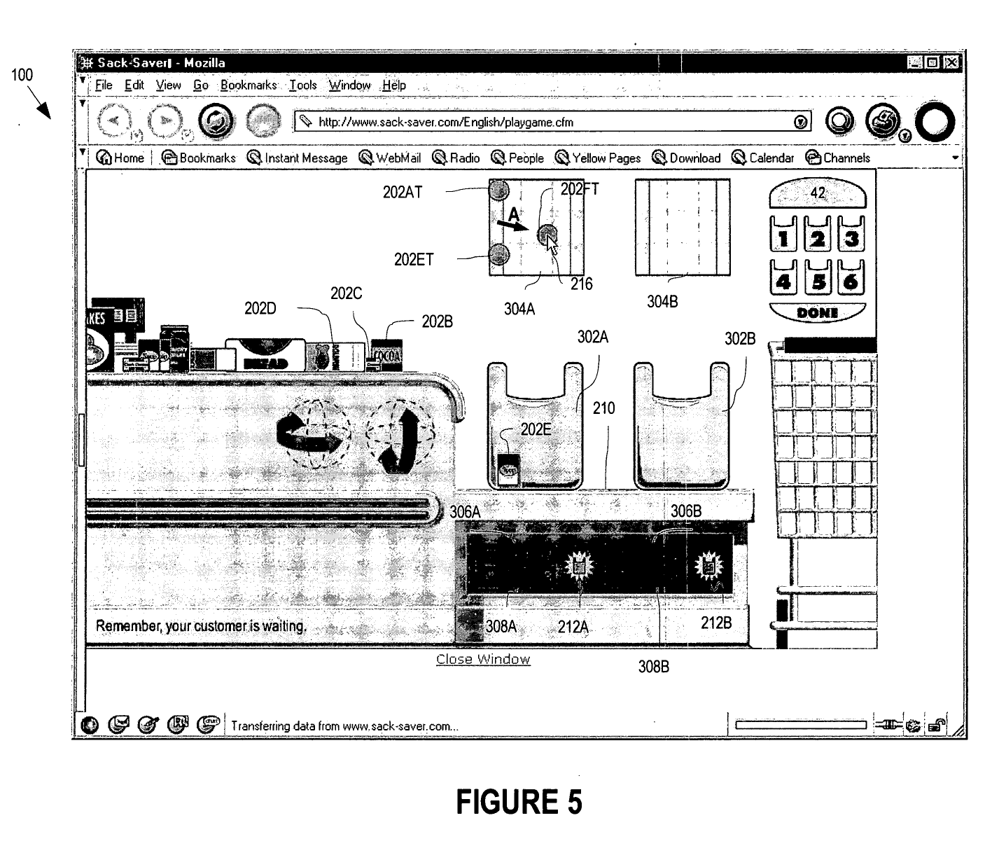

FIG. 4 shows that the trainee has moved items 202A, 202E, and 202F into bag 302A. While only item 202E is visible in the side view of bag 302A, overhead view 304A includes top views 202AT, 202ET, and 202FT of items 202A, 202E, and 202F, respectively. Using cursor 216, the user clicks on top view 202FT of item 202F and drags top view 202FT in the direction of arrow A (FIG. 5). In this manner, core logic 1802 (FIG. 18), through GUI 1804, allows the trainee to control the relative lateral placement of items within bags.

In packing of actual bags, the view of the trainee is typically from the top and organization is generally from a plan-view perspective. In addition, the position of items in lateral relation to one another is particularly important in bag packing. For example, it is generally advisable to place four (4) cans—or other non-crushable items—of substantial size and weight in the four (4) bottom corners of a PRCB to establish a solid foundation for other items to be subsequently packed therein. Accordingly, overhead views 304A-B enable the trainee to specify such placement and are therefore particularly useful in providing a realistic simulation for the trainee.

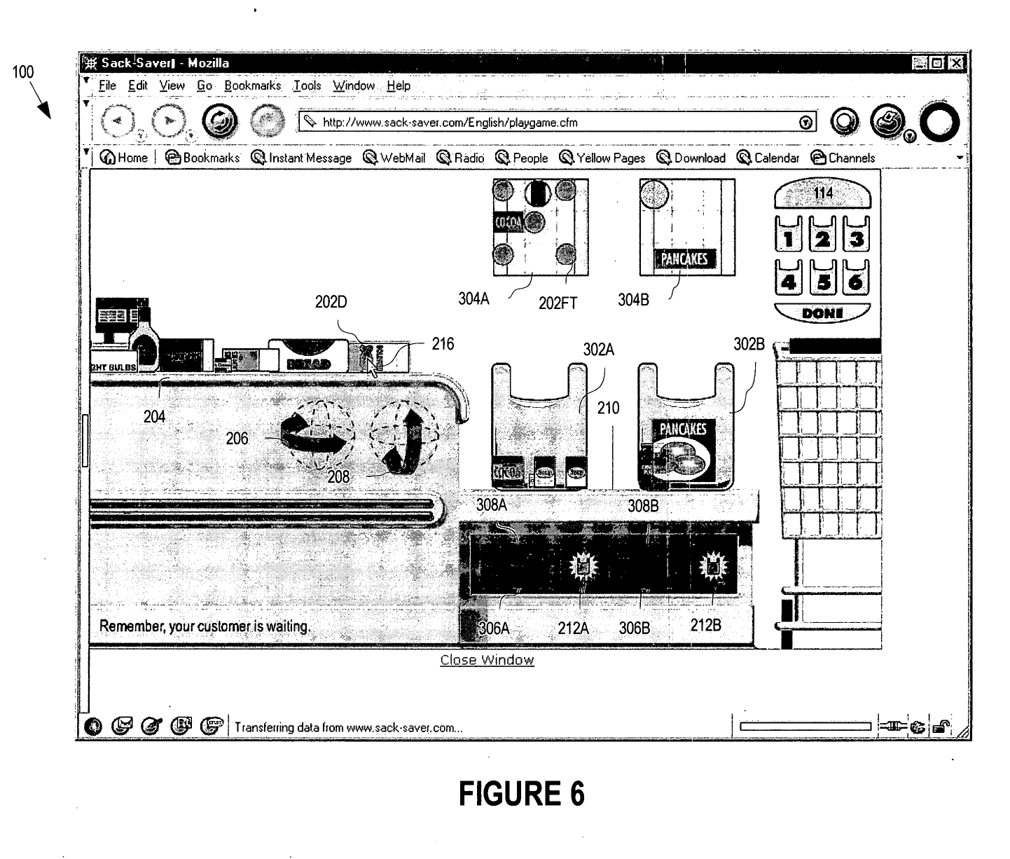

A number of features are provided by core logic 1802 (FIG. 18) to add to the authenticity of the experience of the trainee, and thus to the applicability of the experience to actual packing of bags. As items are packed into bags 302A-B (FIG. 6), the respective weights of the bags as packed are represented as scale readings 306A-B, and respective items counts 308A-B indicate the number of items in each of bags 302A-B. A goal of bag packing is the even distribution of weight across the multiple bags of a particular customer's purchases and a target weight for each bag. The target weight for each bag is selected to minimize bag usage and maximum customer satisfaction. Specifically, if bags are packed too lightly, too many bags are being used and the merchant experiences higher than necessary bag costs. If the bags are packed too heavily, customers begin to experience discomfort in carrying the bags and bags can break, leading to substantial dissatisfaction of the customers.

In packing bags, the trainee should be able to adjust the orientation of an item for proper placement within the bag. Accordingly, core logic 1802 (FIG. 18), in conjunction with GUI 1804, implements a user-interface by which the trainee can manipulate the orientation of an item prior to placement within a bag. As shown in FIG. 6, the trainee clicks on item 202D causing item 202D to be selected. Core logic 1802 (FIG. 18) records items 202D as selected and represents item 202D in a highlighted state. In this illustrative embodiment, the highlighted state is a representation of a yellow outline added to item 202D.

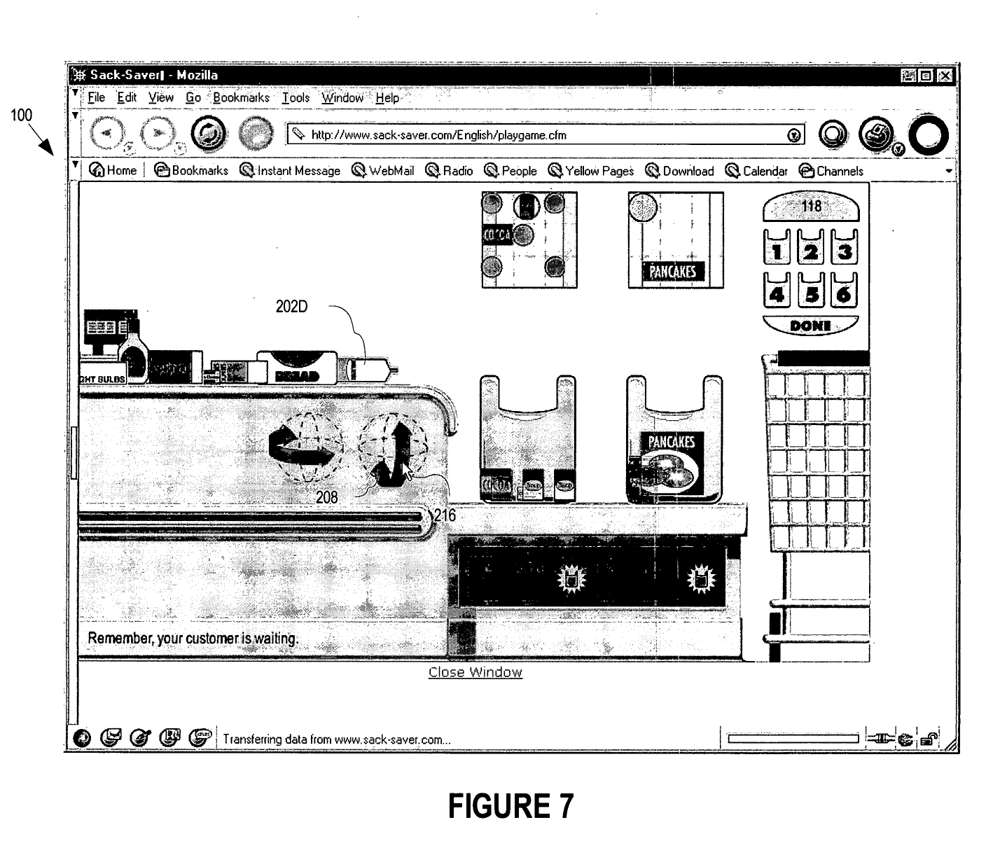

With an item selected, the trainee clicks on either of rotation buttons 206-208. In response to clicking of rotation button 206, core logic 1802 (FIG. 18) rotates the display orientation of the selected item ninety (90) degrees horizontally, i.e., about the y-axis of the selected item as displayed. In response to clicking of rotation button 208 (FIG. 6), core logic 1802 (FIG. 18) rotates the display orientation of the selected item ninety (90) degrees vertically, i.e., about the x-axis of the selected item as displayed. FIG. 7 shows item 202D as rotated after clicking of rotation button 208.

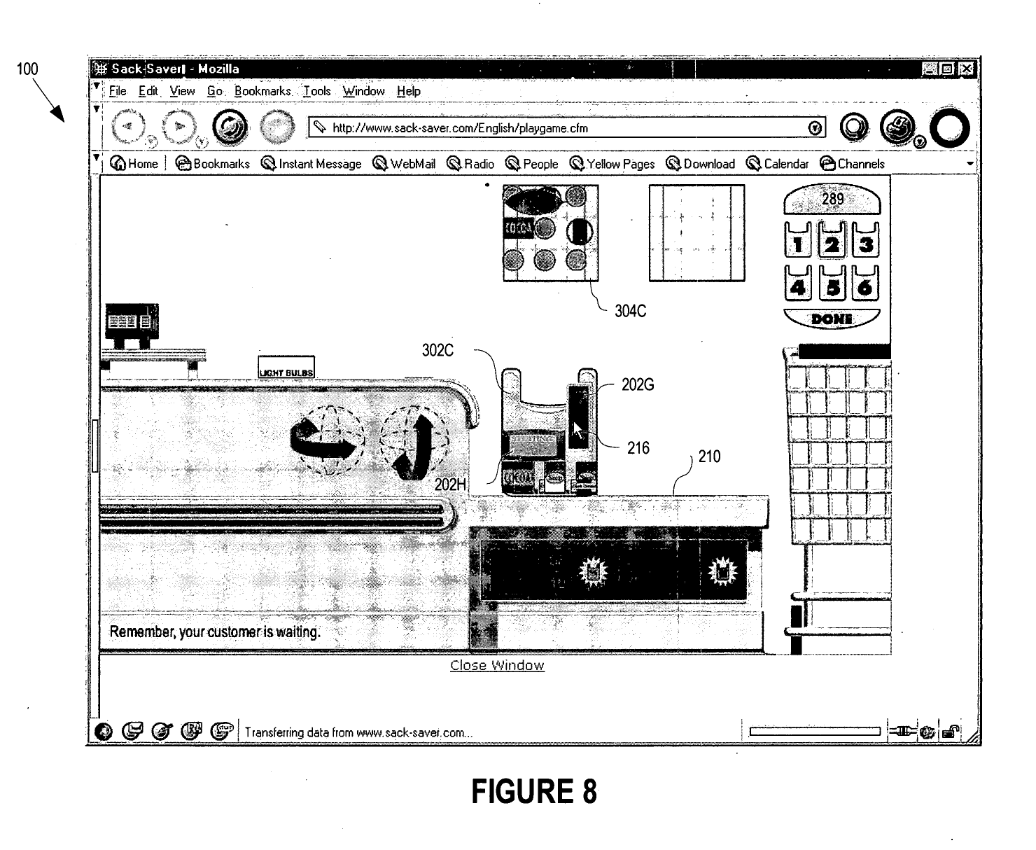

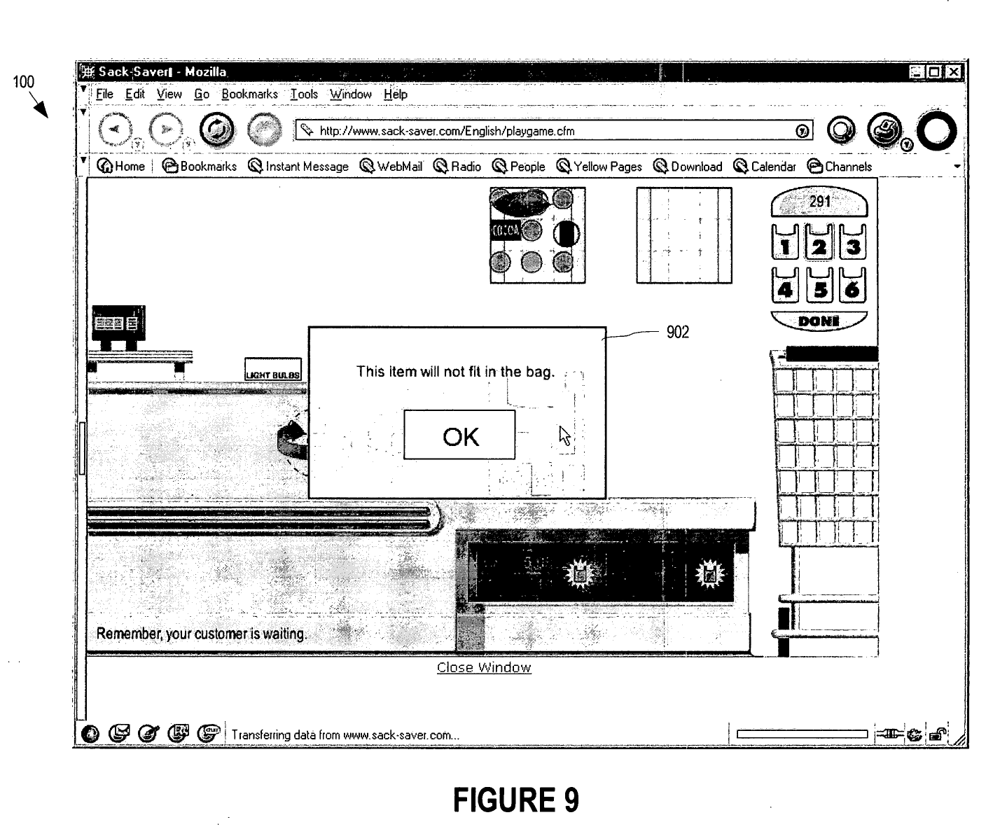

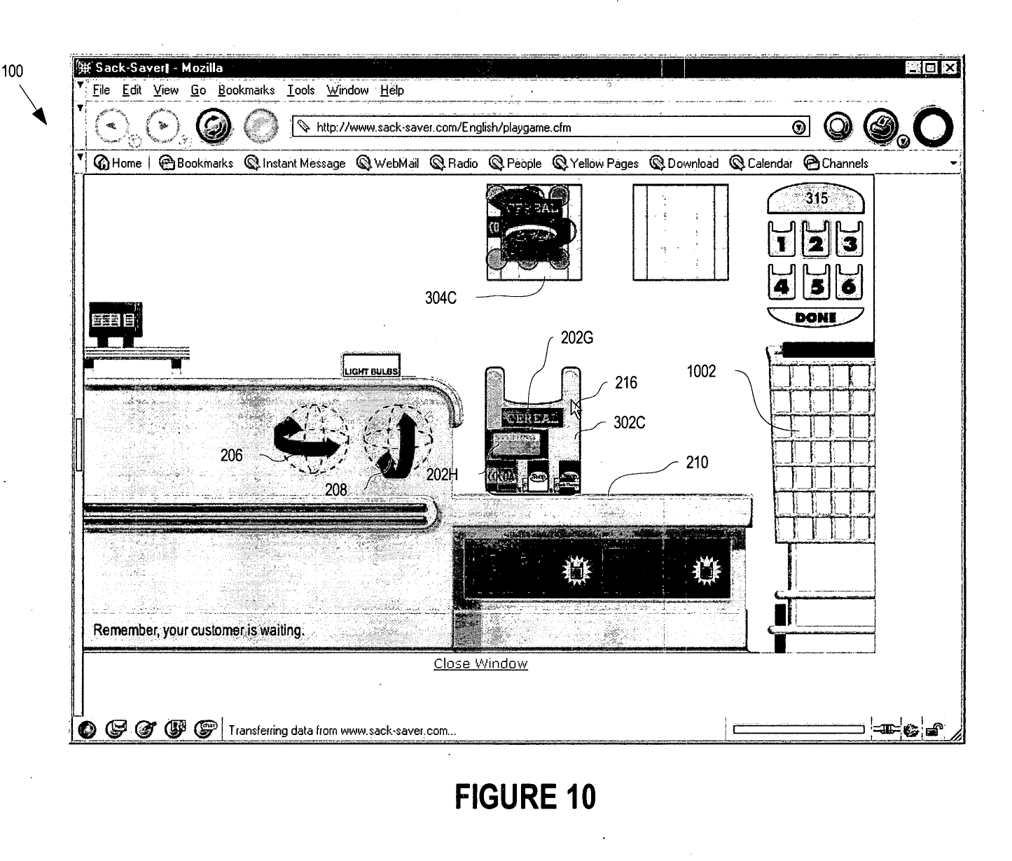

Using rotation buttons 206-208, the trainee can easily and intuitively orient an item to fit in a variety of tight spaces in a bag with other items. An example is shown in FIG. 8. Item 202G has been rotated horizontally ninety (90) degrees to fit in a space within a bag 302C adjacent to item 202H. Core logic 1802 (FIG. 18) detects an item exceeding the boundaries of a bag and displays an error message 902 (FIG. 9). In this illustrative example, item 202G (FIG. 8) does not fit within bag 302C and error message 902 (FIG. 9) so indicates. Using rotation buttons 206-208, the trainee re-orients items 202G as shown in FIG. 10 and item 202G as oriented fits within bag 302C.

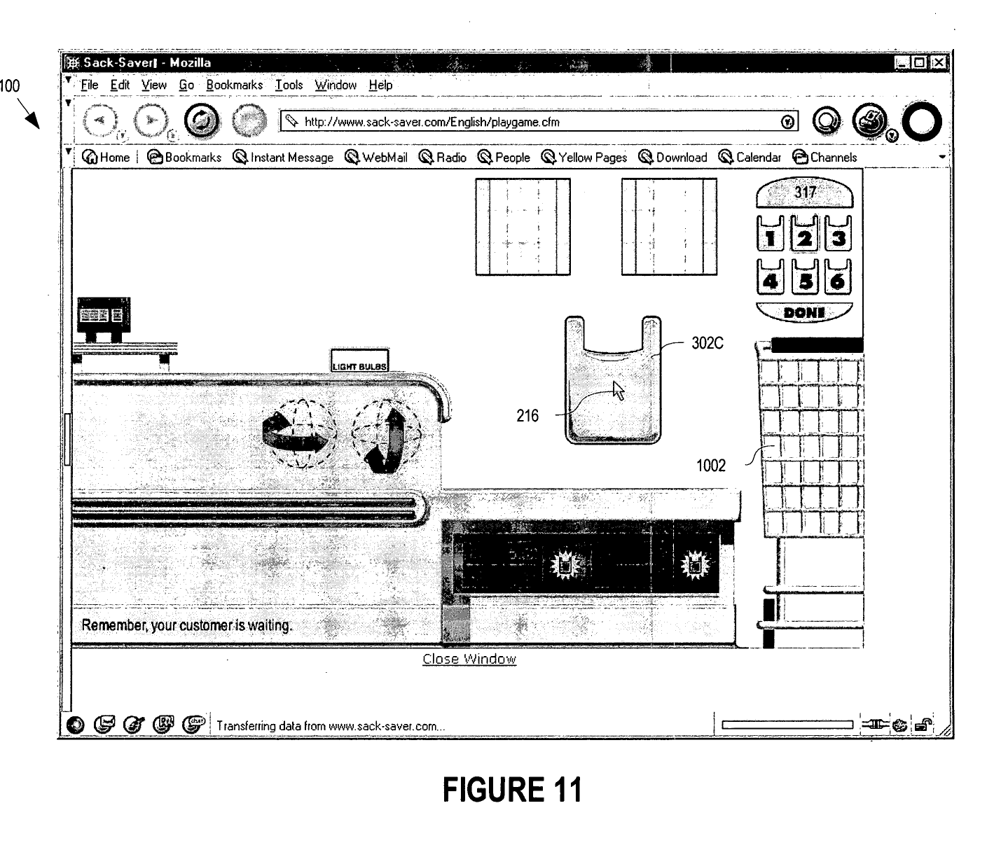

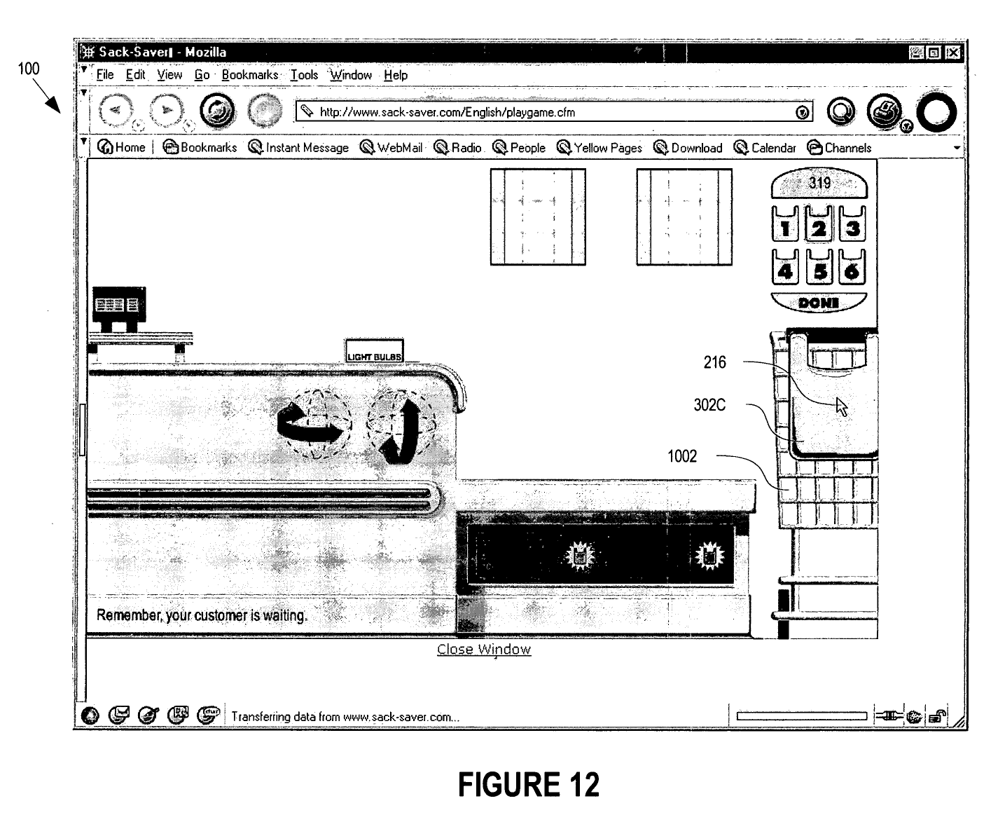

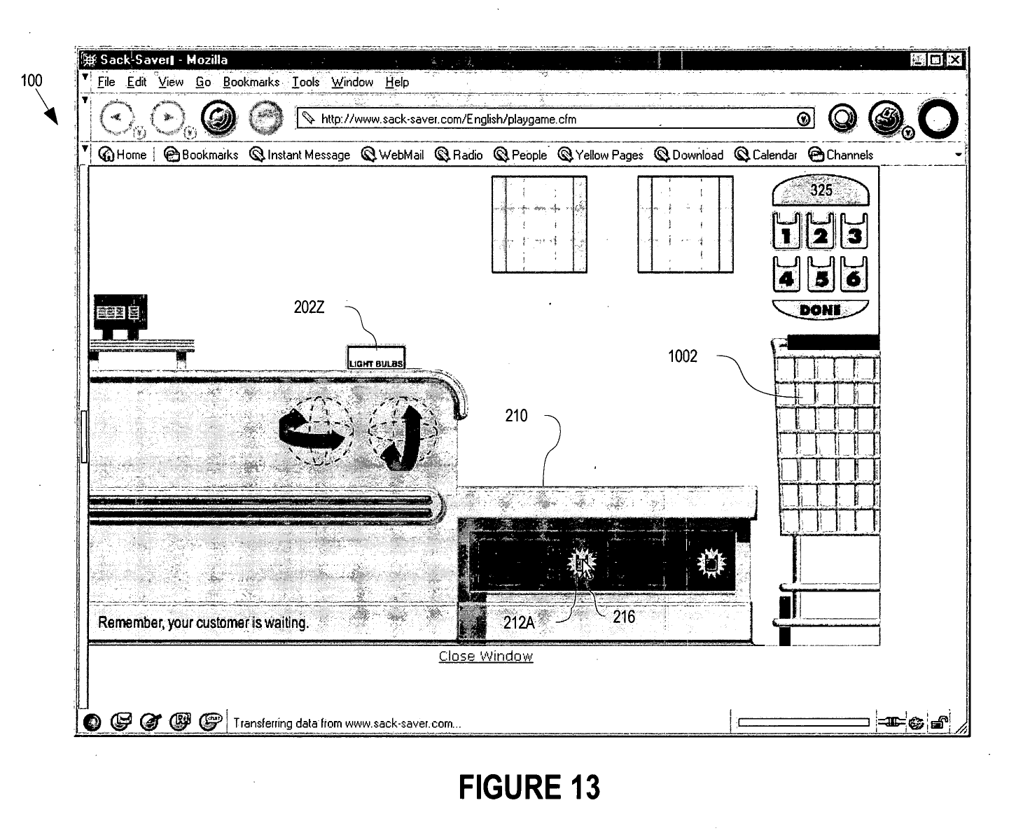

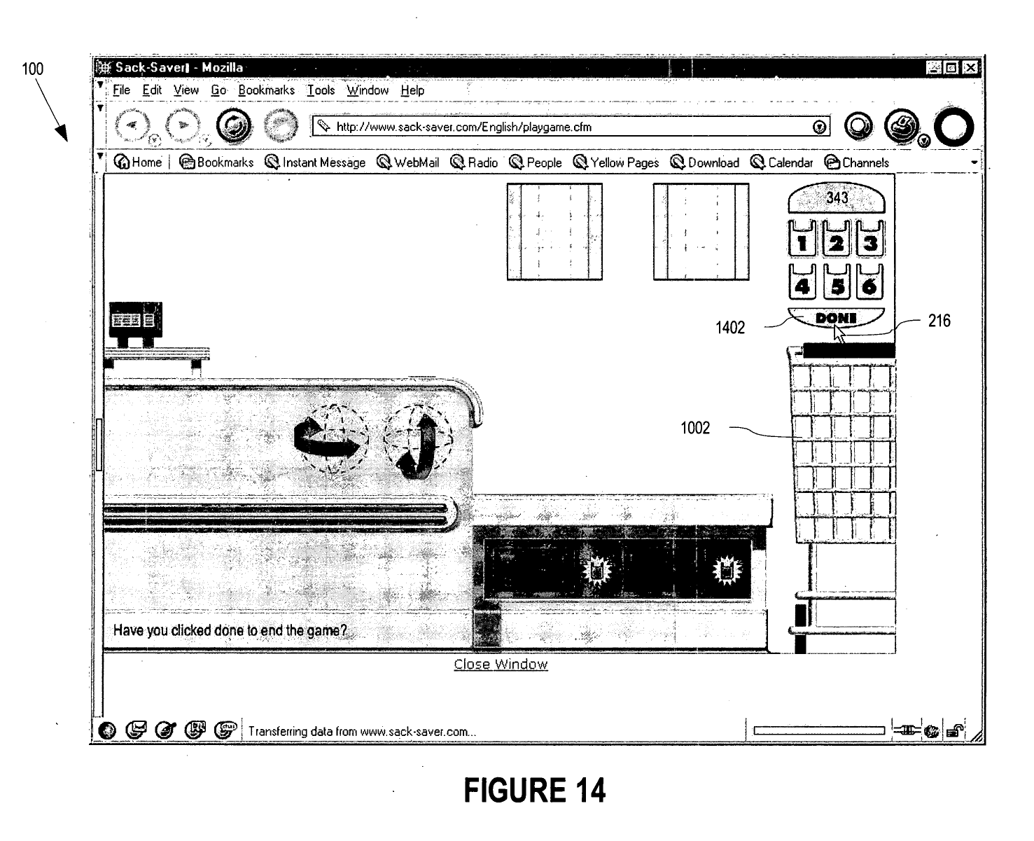

Eventually, the trainee determines that a bag is full. The trainee uses a drag-and-drop user gesture to move bag 302C to cart 1002. Core logic 1802 (FIG. 18), in conjunction with GUI 1804, detects a click with cursor 216 (FIG. 10) over bag 302 and a dragging gesture moving bag 302C (FIG. 11) on to cart 1002 (FIG. 12). Core logic 1802 (FIG. 18) records bag 302C (FIG. 11) as removed from packing platform 210 as shown in FIG. 13. The trainee can now click new bag button 212A to request yet another bag. When the last item 202Z has been packed in a bag and the bag has been dragged and dropped into cart 1002, the trainee clicks a done button 1402 (FIG. 14) to indicate that all items have been packed into bags and the bags have all been placed into cart 1002.

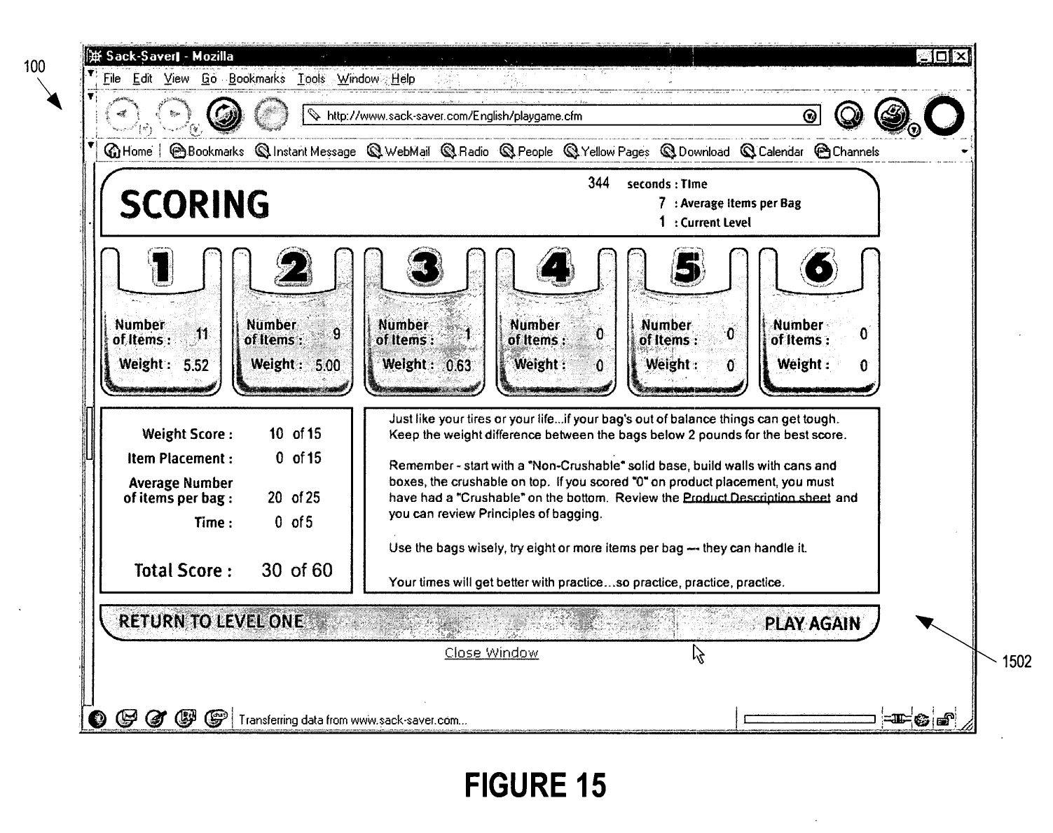

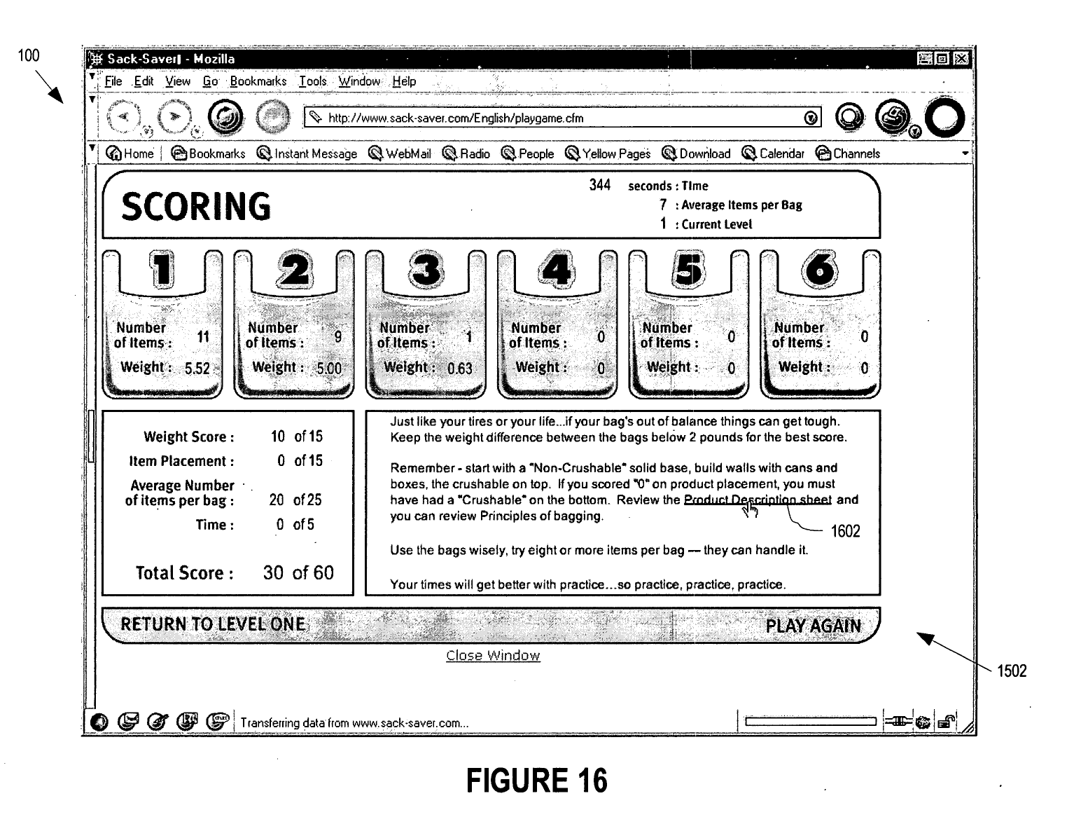

In response to the clicking of done button 1402, core logic 1802 (FIG. 18) sends data representing the various items packed into various bags by the trainee in addition to other information such as the total elapsed time used by the trainee to scoring logic 1812. In response, scoring logic 1812 assesses performance of the trainee and returns data representing such performance assessment to core logic 1802. Such scoring and assessment is described more completely below. Core logic 1802 produces a report page 1502 (FIG. 15) which summarizes the performance of the trainee and represents a quantitative evaluation of the trainee's performance as returned by scoring logic 1812 (FIG. 18). A link 1602 (FIG. 16) included in report page 1502 provides access to more detailed instructions as to the preferred manner of packing bags such that the trainee can review the preferred manner for improved future performance.

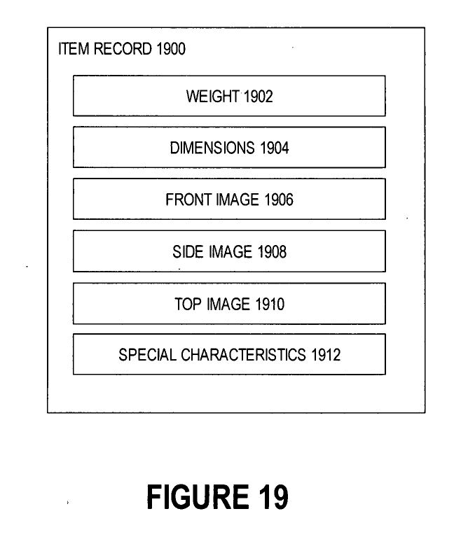

As described briefly above, core logic 1802 (FIG. 18) uses item database 1806 to properly represent items 202A-F (FIG. 2). Such representation includes both appearance and behavior. Item database 1806 (FIG. 18) includes a number of item records, each of which represents a type of item which can be packed into bag in the simulated environment described above. Item record 1900 (FIG. 19) is representative.

Item record 1900 represents a type of item. Multiple items can be associated with a single item record. For example, items 202A (FIG. 2), 202E, and 202F all represent cans of soup and are associated with a single item record defining the appearance and other characteristics of cans of soup. Item record 1900 (FIG. 19) includes a weight field 1902 which specifies the weight of an item. Weights of items packed into a bag are accumulated for display in scale readings 306A-B (FIG. 3) and for scoring in a manner described below.

Dimensions 1904 (FIG. 19) of item record 1900 specifies dimensions of an item. The dimensions are used by core logic 1802 (FIG. 18) in accurately managing placement and spatial relations between items in a single bag. For example, core logic 1802 uses dimensions of respective items represented in bag 302C (FIG. 8) to prevent items from occupying the same space (i.e., overlapping in three-dimensional space) and to properly represent the relative positions of items as packed in bag 302C. In this illustrative embodiment, space in a bag is divided in to 27 cells—namely, three levels vertically, each of which includes nine cells arranged in a three-by-three horizontal square. Accordingly, dimensions represented in dimensions 1904 ((19) specify a number of such cells occupied by an item in each of three dimensions.

Item record 1900 (FIG. 19) includes a number of images by which to represent a type of item. Specifically, front image 1906, side image 1908, and top image 1910 represent front, side, and top views, respectively, of the type of item. In this illustrative embodiment, items are assumed to be generally symmetrical about the 3 axes. Accordingly, a back image is obviated by front image 1906 which would have substantially identical dimensions. A bottom image and another side image are similarly obviated by top image 1910 and side image 1908, respectively.

Special characteristics 1912 of item record 1900 specifies any special characteristics of the type of item. For example, some items are crushable and/or fragile and those are recorded as special characteristics. Other special characteristics include a tendency to absorb odors and a tendency to emit odors. An example use of these latter special characteristics is that the trainee is discouraged from packing laundry detergent and meats in the same bag as the scent and/or taste of the detergent can be passed to and absorbed by the meat. Such discouragement is provided by scoring logic 1812 which detects placement of odor absorbing and odor emitting items in the same bag and provides a particularly low score in such instances.

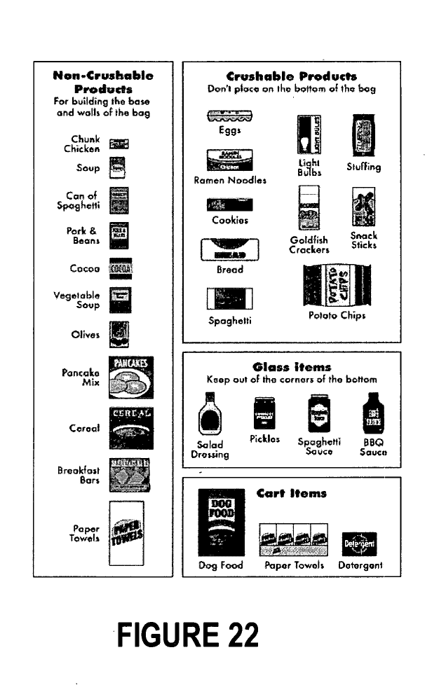

In this illustrative embodiment, special characteristics 1912 are represented as one of four (4) categories: crushable, non-crushable, glass, and cart items. Crushable items, such as eggs, light bulbs, and potato chips, should not be placed under other items. Glass items are not crushable and can therefore be placed under other items. However, glass items should not be placed in the corners of the bottom level of a bag. Non-crushable items can be placed under other items and can be placed at bottom corners of the bags. Cart items should be placed directly in carts and not in bags. FIG. 22 shows front images of a number of item types organized in respective categories in accordance with this illustrative embodiment.

Randomizer 1810 and difficulty module 1908 can combine in any of a number of ways to produce many levels and variations of difficulty. For example, in easier levels, randomizer 1810 can select items in relatively close relation to an optimal order in which the items would be packed into bags while, in more difficult levels, the order of appearance of items can be far from optimal. Similarly, randomizer 1810 can select mostly non-crushable items in easier levels and mostly other types in more difficult levels. Randomizer 1810 can be configured to produce pseudo-random numbers according to a variety of random distributions. Difficulty module 1908 can control a number of factors of the behavior of the simulated bag packing environment of core logic 1802, such as the time permitted to pack the bags, the number and categories of items to be packed in the bags, the order of appearance of items, etc.

In this illustrative embodiment, there are three (3) levels of difficulty. In level one, twenty (20) items, one of which in a cart item, appear. The user has one minute to pack the items into bags. In each play of the simulated bag packing environment, the same items appear in the same order. In level two, thirty (30) items, two of which are cart items, must be packed in bags in the same one minute. In each play, the same items appear in a randomized order. In level three, forty (40) items, three of which are cart items, must be packed in bags in the same one minute. In each play, the same items appear in a randomized order.

Scoring logic 1812 quantifies performance by the trainee in packing the bags in the manner described above with respect to FIGS. 1-16. Scoring logic 1812 can employ generally any of the scoring calculations used in regional and national “Best Bagger” competitions. Such scoring generally includes sub-scores for the average number of items per bag, the placement of items within bags (commensurate with the categories described above), the average weight and weight variance of the bags, and the time taken to pack the bags.

In this illustrative embodiment, scoring logic 1812 scores up to fifteen (15) points for performance categories of weight distribution and item placement, scores up to twenty-five (25) points for the performance categories of the number of items per bags, and scores up to five (5) points for time efficiency.

Scoring logic 1812 evaluates weight distribution by determining the maximum weight difference between any bags packed by the trainee. If the maximum weight difference is less than two (2) pounds, scoring logic 1812 awards the maximum score is fifteen (15) points for weight distribution. If the maximum weight difference is at least two (2) pounds but less than three (3) pounds, scoring logic 1812 awards only ten (10) points for weight distribution. If the maximum weight difference is at least three (3) pounds, scoring logic 1812 awards no points for weight distribution.

Scoring logic 1812 evaluates items placement by comparing placement of items within the bags to rules associated with special characteristics as represented in special characteristics 1912 ((19). As described above, space in each bag is divided in to 27 cells—namely, three levels vertically, each of which includes nine cells arranged in a three-by-three horizontal square in this illustrative embodiment. Scoring logic 1812 does not deduct any points in item placement for placement of non-crushable items. If scoring logic 1812 determines that a glass item is placed in a corner cell of the bottom level of a bag, scoring logic 1812 deducts two (2) points from the score for item placement. If scoring logic 1812 determines that crushable item occupies any cell on the bottom level of a bag, scoring logic 1812 awards no points for item placement. Core logic 1802 does not permit placement of cart items in bags, so scoring logic 1812 does not consider the contingency that a cart item might be placed in a bag.

A total of twenty-five (25) points is associated with the number of items per bag because the number of items per bag is a primary focus. In particular, the total number of bags used is to be minimized to thereby reduce the costs associated with providing bags to customers. Currently, most retail stores, grocery and otherwise, average about three (3) items per bag.

Scoring logic 1812 determines the average number of items per bag achieved by the trainee by dividing the total number of items placed in bags by the number of bags used. If the average is at least eight (8), scoring logic 1812 awards a full twenty-five (25) points for the number of items per bag. If the average is less than eight (8) but at least five (5), scoring logic 1812 awards twenty (20) points for the number of items per bag. If the average is less than five (5) but at least four (4), scoring logic 1812 awards ten (10) points for the number of items per bag. If the average is less than four (4), scoring logic 1812 awards no points for the number of items per bag.

Scoring logic 1812 measures time efficiency of the trainee by measure the time that elapses between start of play at the clicking of the “Let's Play” button shown in FIG. 1 and the end of play at the clicking of done button 1402 ((14) with all items packed in bags. If the elapsed time is less than 120 seconds (two minutes), scoring logic 1812 ((18) awards the trainee a full five (5) points for time efficiency. If the elapsed time is at least 120 seconds but less than 130 seconds, scoring logic 1812 awards the trainee three (3) points for time efficiency. If the elapsed time is at least 130 seconds, scoring logic 1812 awards the trainee no points for time efficiency.

Scoring logic 1812 accumulates the weight distribution, item placement, items per bag, and time scores to provide a cumulative score of zero to sixty (60). Core logic 1802 advances the trainee from the first level of difficulty to the second level of difficulty when the trainee has scored at least fifty (50) points at the first level of difficulty. When the trainee has scored at least fifty (50) points at the second level of difficulty, core logic 1802 advances the trainee to the third level of difficulty. Training is considered complete in this illustrative embodiment when the trainee has scored at least fifty (50) points at the third level of difficulty. In this illustrative example, the trainee is given the opportunity to request reversion to a lower level of difficulty by providing a GUI button so indicating.

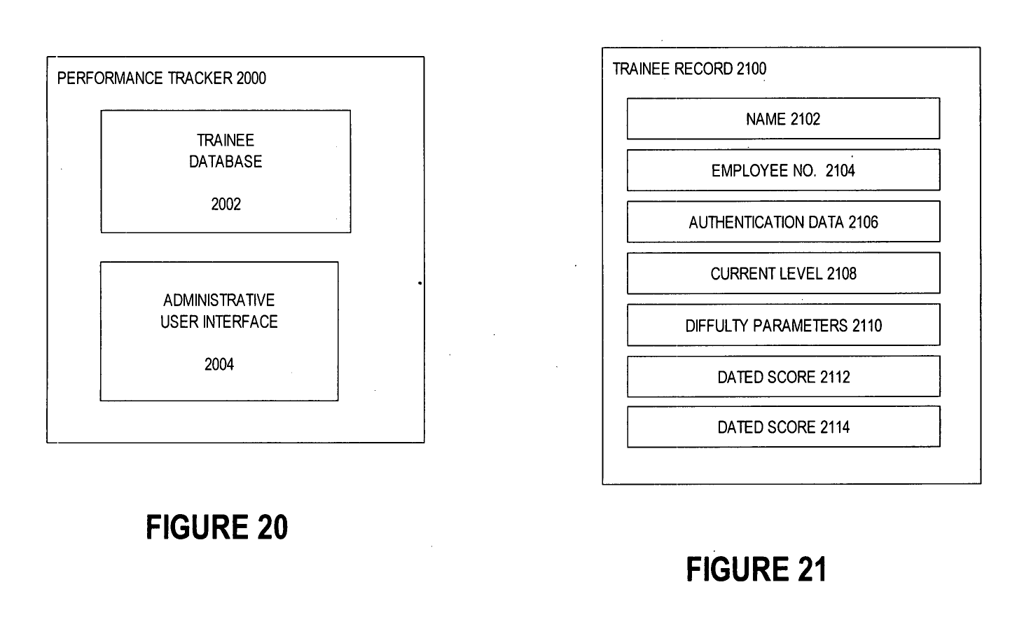

Performance tracker 2000 (FIG. 17) is shown in greater detail in FIG. 20. Performance tracker 2000 includes a trainee database 2002 and an administrative user interface 2004. Administrative user interface 2004 provides a user interface by which administrators can add, edit, and delete individual records for trainees. Such administrators can add new trainee records for new trainees, review performance of trainees in the simulated bag packing environment described above, and control access to use of trainer logic 1800. It is preferred that administrative user interface 2004 includes authentication logic such that only specifically authorized administrators can manually modify records stored in trainee database 2002.

Trainee database 2002 includes a number of trainee records, of which trainee record 2100 (FIG. 21) is representative. Trainee record 2100 includes a name field 2103 and an employee number field 2104 and generally any other data by which a particular trainee is identified and or distinguished from other trainees. The particular trainee represented by trainee record 2100 and identified by name field 2102 and employee number field 2104 is sometimes referred to as the subject trainee in the context of FIG. 21.

Authentication data field 2106 represents data by which the subject trainee is authenticated prior to use of trainer logic 1800. In this illustrative example, authentication data field 2106 stores a username and an associated password which are entered by the subject trainee prior to being granted access to trainer logic 1800.

Current level field 2108 specifies a current level of difficulty achieved by the subject trainee in prior use of trainer logic 1800. Difficulty parameters 2110 specify in greater detail specific parameters influencing the difficulty of play of trainer logic 1800 in a most recent use of trainer logic 1800. Accordingly, when the subject trainee returns for resumed training through trainer logic 1800, play resumes at precisely the level of difficulty most recently achieved by the subject trainee.

A number of dated scores 2112, 2114, etc. track performance of the subject trainee over time. Such facilitates both tracking progress of the subject trainee in achieving proficiency in bag packing and measuring the efficacy of trainer logic 1800 in improving bag packing skills generally.

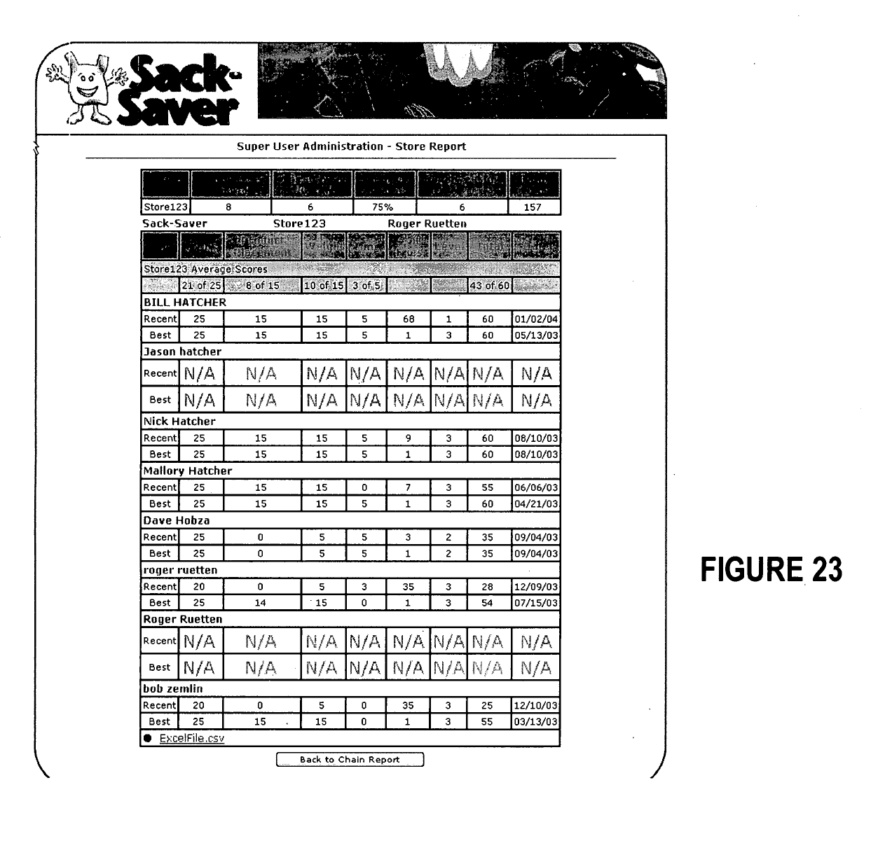

FIG. 23 shows an illustrative example of a report of individual trainees' performance in using the simulated bag packing environment of FIGS. 1-16. In this illustrative report, recent and best scores are reported for each trainee. In addition, scores are broken down into sub-scores such as the average number of items per bag, the placement of items within bags (commensurate with the categories described above), the average weight and weight variance of the bags, and the time taken to pack the bags. Administrative user interface 2004 can also provide fully detailed reports of all training activity of all trainees.

The above description is illustrative only and is not limiting. Instead, the present invention is defined solely by the claims which follow and their full range of equivalents.

1. A method for training a user to perform a task which includes movement of two or more items from a randomized state to an organized state, the method comprising:
representing in a computer the items in the randomized state;
moving the items as represented within the computer in accordance with signals generated by the user; and
verifying in the computer that the items as moved are in the organized state.

2. The method of claim 1 wherein the task is packing retail carrier bags.

3. The method of claim 1 wherein the task includes movement of two or more items from a randomized state to an organized state within a container.

4. The method of claim 1 further comprising:
quantifying a score for the user based on one or more rules governing the organized state.

5. The method of claim 4 wherein the organized state is a state of the items packed in at least one carrier.

6. The method of claim 5 wherein quantifying comprises:
determining that a crushable one of the items in the organized state is in a lower position within the carrier.

7. The method of claim 5 wherein quantifying comprises:
determining that a breakable one of the items in the organized state is in a lower corner position within the carrier.

8. The method of claim 5 wherein the at least one carrier includes two or more carriers and further wherein quantifying comprises:
measuring distribution of weight among the two or more carriers.

9. The method of claim 5 wherein quantifying comprises:
determining a number of items per carrier in the organized state.

10. The method of claim 5 wherein quantifying comprises:
determining an amount of time taken to perform the task to achieve the organized state.

11. The method of claim 4 further comprising:
recording the score along with one or more other previously quantified scores for the user in a database accessible to administrators through a computer network.

12. A computer readable medium useful in association with a computer which includes a processor and a memory, the computer readable medium including computer instructions which are configured to cause the computer to train a user to perform a task which includes movement of two or more items from a randomized state to an organized state by:
representing in a computer the items in the randomized state;
moving the items as represented within the computer in accordance with signals generated by the user; and
verifying in the computer that the items as moved are in the organized state.

13. The computer readable medium of claim 12 wherein the task is packing retail carrier bags.

14. The computer readable medium of claim 12 wherein the task includes movement of two or more items from a randomized state to an organized state within a container.

15. The computer readable medium of claim 12 wherein the computer instructions are configured to cause the computer to train the user to perform the task by also:
quantifying a score for the user based on one or more rules governing the organized state.

16. The computer readable medium of claim 15 wherein the organized state is a state of the items packed in at least one carrier.

17. The computer readable medium of claim 16 wherein quantifying comprises:
determining that a crushable one of the items in the organized state is in a lower position within the carrier.

18. The computer readable medium of claim 16 wherein quantifying comprises:
determining that a breakable one of the items in the organized state is in a lower corner position within the carrier.

19. The computer readable medium of claim 16 wherein the at least one carrier includes two or more carriers and further wherein quantifying comprises:
measuring distribution of weight among the two or more carriers.

20. The computer readable medium of claim 16 wherein quantifying comprises:
determining a number of items per carrier in the organized state.

21. The computer readable medium of claim 16 wherein quantifying comprises:
determining an amount of time taken to perform the task to achieve the organized state.

22. The computer readable medium of claim 15 wherein the computer instructions are configured to cause the computer to train the user to perform the task by also:
recording the score along with one or more other previously quantified scores for the user in a database accessible to administrators through a computer network.

23. A computer system comprising:
a processor;
a memory operatively coupled to the processor; and
a training module (i) which executes in the processor from the memory and (ii) which, when executed by the processor, causes the computer to train a user to perform a task which includes movement of two or more items from a randomized state to an organized state by:
representing in a computer the items in the randomized state;
moving the items as represented within the computer in accordance with signals generated by the user; and
verifying in the computer that the items as moved are in the organized state.

24. The computer system of claim 23 wherein the task is packing retail carrier bags.

25. The computer system of claim 23 wherein the task includes movement of two or more items from a randomized state to an organized state within a container.

26. The computer system of claim 23 wherein the training module, when executed by the processor, causes the computer to train the user to perform the task by also:
quantifying a score for the user based on one or more rules governing the organized state.

27. The computer system of claim 26 wherein the organized state is a state of the items packed in at least one carrier.

28. The computer system of claim 27 wherein quantifying comprises:
determining that a crushable one of the items in the organized state is in a lower position within the carrier.

29. The computer system of claim 27 wherein quantifying comprises:
determining that a breakable one of the items in the organized state is in a lower corner position within the carrier.

30. The computer system of claim 27 wherein the at least one carrier includes two or more carriers and further wherein quantifying comprises:
measuring distribution of weight among the two or more carriers.

31. The computer system of claim 27 wherein quantifying comprises:
determining a number of items per carrier in the organized state.

32. The computer system of claim 27 wherein quantifying comprises:
determining an amount of time taken to perform the task to achieve the organized state.

33. The computer system of claim 26 wherein the training module, when executed by the processor, causes the computer to train the user to perform the task by also:
recording the score along with one or more other previously quantified scores for the user in a database accessible to administrators through a computer network.
